(19) United States
(12) Patent Application Publication
(10) Pub. No.: US 2009/0174767 A1
(43) Pub. Date: Jul. 9, 2009

(54) Photographic device and method of photographic inspected portion of subject

(76) Inventors: Toru Kishimoto, Aichi-ken (JP); Eiji Amaki, Aichi-ken (JP); Yukiyoshi Umeda, Aichi-ken (JP); Naoyuki Sugiura, Aichi (JP)

Correspondence Address: BACON & THOMAS, PLLC, 625 SLATERS LANE, FOURTH FLOOR, ALEXANDRIA, VA, 22314-1176, US

(21) Appl. No.: 10/585,187

(22) PCT Filed: Mar. 7, 2005
(86) PCT No.: PCT/JP05/03904

§ 371 Date: Jul. 3, 2006

(30) Foreign Application Priority Data
Mar. 5, 2004 (JP) 2004-062433

(51) Int. Cl. H04N 7/18

(52) U.S. Cl. 348/92; 348/E07.085

(57) ABSTRACT

A digital camera 28 that is capable of color photography and that has an automatic exposure-adjustment function and an automatic focusing function is mounted in such a way that it can be swiveled by means of a tilt device 29 to a prescribed position in relation to a photographed object 30. The digital camera is swiveled by the tilt device such that the center of the screen moves along a predetermined prescribed route 31 a on subject surface 31. Every time the digital camera's field of view reaches a prescribed location on the route, a portion of the subject surface and a portion of a member 35 that is set on the subject surface are photographed by the digital camera as a photographed range. It is desirable to adjust the focal distance of the digital camera such that the image resolution of each photographed range is nearly constant. The photographed member is a liquid gasket that is applied in bead form along the route and that is detected as defective if its width exceeds a prescribed range.

### TECHNICAL FIELD

The present invention relates to a photographic device and a method of photographing an inspected portion of a subject. The present invention relates particularly to a photographic device and a method of photographing in which the subject is a joining end face of an automatic transmission housing of any shape, for example, or a sealing member that is applied to the joining end face, and by which device and method the state of adhesion of the joining end face or of the sealing member on the joining end face can be accurately inspected by means of an image.

### BACKGROUND ART

In Japanese Patent Application Publication No. JP-A-8 (1996)-334478, a method of inspecting the state of application of a paste-type sealing member that is applied to a joining end face of a workpiece by an automatic application device is disclosed. In this method, the centers of images taken by a plurality of CCD cameras are specified as the inspection points. The system inspects the pixels in the width dimension of each image, starting from both sides and working toward the center. The two edges of the sealing member that is the subject are located by finding the positions at which the change in value from one pixel to the next exceeds a set value. Where two edges cannot be detected, a break in the sealing member is judged to exist at that inspection point. The CCD camera that is used in this inspection method is in a fixed position relative to the workpiece and takes monochrome images of the joining end face. Each CCD camera is set at such a distance from the workpiece that the workpiece is photographed with an effective number of pixels in the range of 4 to 6 pixels.

In the inspection method described above, the sealing member is identified by the values of pixels in monochrome images taken by CCD cameras. But the values of the pixels in the images of the sealing member vary according to the position of the lighting and the level of illumination, or due to shadows from pins, etc., located in the vicinity of the joining end face of the workpiece. When the presence or absence of breaks in the sealing member is judged in this sort of inspection environment, there is concern that the judgment could be erroneous due to the variation in the pixel values in the images. Although this problem can be solved by enclosing the photographed location to keep out ambient light, so that the illumination level is controlled, equipment expenses increase as a result.

Another problem with the inspection method described above is that because breaks in the sealing member are judged at predetermined inspection points, continuous detection of breaks in the sealing member is impossible. The technologies that have been proposed to solve this problem involve acquiring binarized or grayscale CCD camera images of the joining end face to which the sealing member has been applied and then carrying out image processing on a plurality of areas that have been defined as areas where the sealing member is present. If the pixels in one image are continuous with those in the preceding image, the technology judges that there is no break in the sealing member. If the pixels are not continuous, the technology judges that there is a break in the sealing member. In the practice of this technology, for example, where a joining end face with an outline 360 mm wide by 300 mm high is photographed using a CCD camera in which the effective number of pixels is 640 in the width direction and 480 in the height direction, the resolution of the image in the width direction is 360 mm÷480 pixels, or approximately 0.75 mm/pixel. Once noise is taken into account, this becomes 1 mm/pixel, which means that breaks of less than 1 mm in the sealing member cannot be detected. A plurality of CCD cameras can be used to increase the resolution, so for example, if 4 CCD cameras are used, so that the joining end face is divided among 4 images, a resolution of approximately 0.5 mm/pixel is obtained. If 25 CCD cameras are used, so that the joining end face is divided among 25 images, a resolution of approximately 0.2 mm/pixel is obtained, even taking noise into account. However, because the number of CCD cameras increases, the equipment expenses also increase.

### DISCLOSURE OF THE INVENTION

In order to address the problems described above, the main object of the present invention is to provide a method of photographing and a photographic device that can accurately inspect the state of adhesion of a member such as a sealing member, etc., in an inspected portion of a subject by using a single CCD camera that has an automatic focusing function to photograph, as a subject, a paste-type sealing member that is applied to a joining end face of an automatic transmission housing, etc., that has any type of shape.

According to the present invention, the object described above is achieved by a method of photographing an inspected portion of a subject in such a way that the condition of the subject can be inspected. This is achieved by arranging a camera that has an automatic focusing function in such a way that it can swivel to a prescribed position facing the subject to be inspected; by swiveling the camera in such a way that its field of view moves sequentially along an inspected portion of the subject; by using the camera to capture an image every time the camera's field of view reaches an inspected portion of the subject; and by processing the image data of the inspected portion that was photographed. By this method of photographing, an inspected portion of the subject can be accurately inspected by photographing it at an optimum resolution for the size of the subject and the shape of the inspected portion.

In the practice of the present invention, it is desirable for the camera to have an automatic exposure function such that the exposure can be automatically adjusted when an inspected portion of the subject is photographed in color. This makes it possible to inspect the inspected portion of the subject even more accurately, because it reduces variations in the image brightness due to ambient light, even if the illumination is not controlled by keeping ambient light out of the area surrounding the inspected portion of the subject. It is also desirable for the camera to have a focal distance change function such that the range that is photographed every time the camera's field of view reaches an inspected portion of the subject is substantially constant. This allows the camera's focal distance to be adjusted automatically according to the distance to the subject, so that the image resolution of the inspected portion of the subject is kept constant, yielding uniform image data of the photographed subject that is suitable for image processing.

The object described above is also achieved by a method of inspecting the state of adhesion of a paste-type member. In this method, a camera that has an automatic focusing function is arranged in such a way that it can swivel to a prescribed position facing the subject, to the upper surface of an outer edge of which a paste-type member adheres in the form of a continuous strip. The camera swivels in such a way that its field of view moves sequentially along an outer edge of the subject. The camera captures an image every time its field of view reaches an inspected portion of the paste-type member that adheres in the form of a strip to the upper surface of an outer edge of the subject. Color or shading is extracted from the captured image and noise is deleted from the image data of the captured image. The width of the extracted strip-shaped region of the paste-type member is sequentially detected, and the strip-shaped region is judged as to whether or not it is of a prescribed width. The state of adhesion of the paste-type member is judged to be defective if the width of the detected strip-shaped region is judged to be too much wider or too much narrower than the prescribed width. In this inspection method, it is desirable for the judgment result as to whether the width of the detected strip-shaped region is too much wider or too much narrower than the prescribed width to be displayed on a display device.

The object described above is also achieved by a photographic device for inspecting the condition of a member that adheres to an inspected portion of the subject. The device is provided with a camera that has an automatic focusing function and is arranged in such a way that it can swivel to a prescribed position facing the subject to be inspected. The device has driving means for driving the camera in such a way that the camera's field of view moves sequentially along an inspected portion of the subject, as well as means for operating the camera in such a way that every time its field of view reaches an inspected portion of the subject, the camera photographs the inspected portion. The device includes image processing means for processing the image data of an inspected portion that was photographed by the camera. In the practice of the photographic device, it is desirable for the camera to have a focal distance change function such that the camera's focal distance can be adjusted automatically, so that the image resolution of the range that is photographed every time the camera's field of view reaches an inspected portion of the subject is substantially constant.

### BRIEF DESCRIPTION OF THE DRAWINGS

FIG. 1 is a side view of a liquid gasket application and detection line that uses a method of photographing inspected portions of a subject in accordance with the present invention;

FIG. 2 is a plan view of the liquid gasket application and detection line shown in FIG. 1;

FIG. 3 is a plan view showing a transmission housing joining end face that is a photographic subject;

FIGS. 4A to 4B are photographs showing an image of a liquid gasket that was applied to a joining end face of a transmission housing and was photographed by the camera shown in FIG. 1, plus liquid gasket image data that was extracted from the image; and

FIG. 5 is a flowchart that shows one embodiment of a method of detecting the state of adhesion of a liquid gasket that is a subject.

### BEST MODES FOR CARRYING OUT THE INVENTION

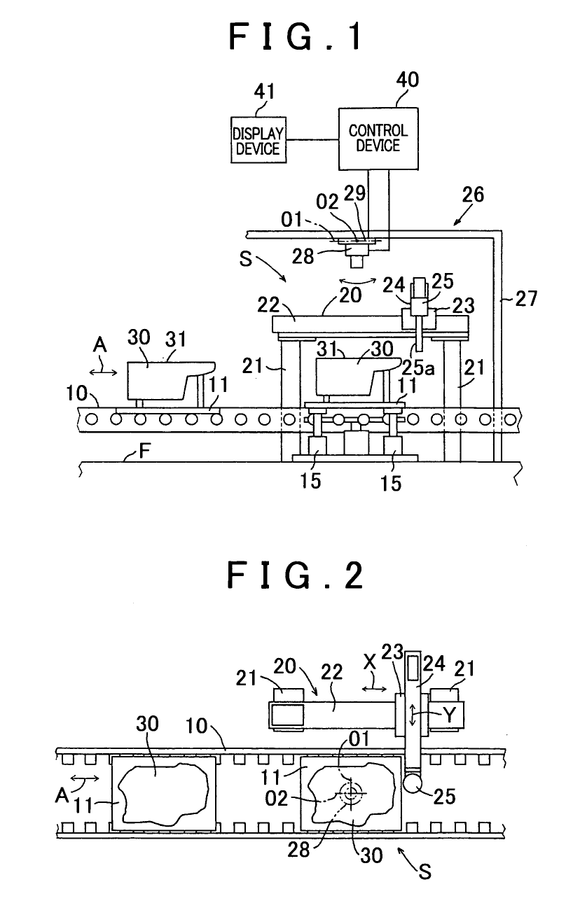

A liquid gasket application and detection line that uses a method of photographing inspected portions of a subject in accordance with the present invention will be explained below with reference to FIGS. 1 to 3. As shown in FIGS. 1 and 2, a roller conveyor (transport device) 10 that transports a pallet 11, on which is mounted a transmission housing 30, is installed on a floor F parallel to a direction A. A liquid gasket (paste-type sealing member) application and detection station S is located at the outgoing end of the roller conveyor 10. The application and detection station S is provided with a liquid gasket application device 20 and a digital camera 28, which has an automatic focusing function and is mounted by means of a tilt device 29 on an upper supporting portion of a support frame 27. The pallet 11 on which the transmission housing 30 is mounted is stopped at the application and detection station S, where it is lifted and held in a prescribed position by a cylinder device 15 that is installed on the floor F.

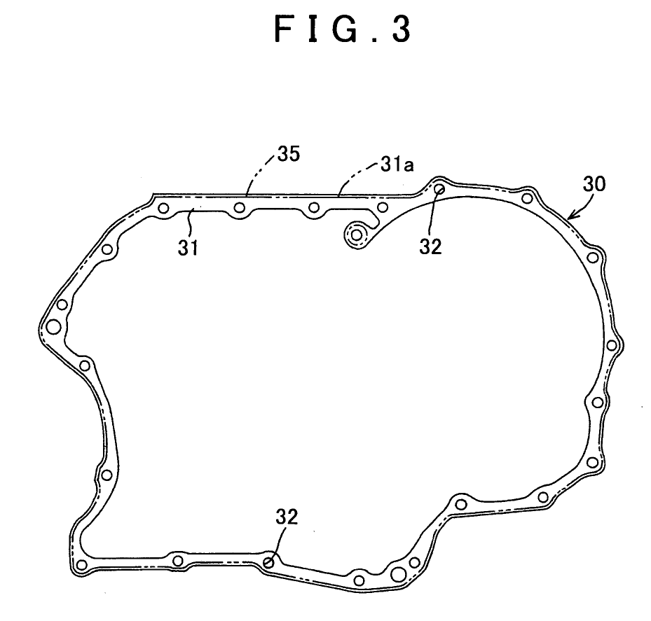

The transmission housing 30 is mounted on the pallet 11 such that a joining end face 31 is positioned on the top side. As shown in FIG. 3, the joining end face 31 of the transmission housing 30 is provided with a plurality of fastening holes 32 along its periphery. A liquid gasket 35 is applied to the top surface of an outer edge 31a that is located on the outer side of the periphery.

As shown in FIGS. 1 and 2, the liquid gasket application device 20 is provided with an XY robot that is configured from a fixed rail 22, a moving platform 23, and a moveable rail 24. The fixed rail 22 is mounted in a direction X parallel to the direction A and is affixed to the top ends of a pair of columns 21 that are secured to the floor F along one side of the roller conveyor 10. The moving platform 23 is supported and guided by the fixed rail 22 such that it can move in the direction X. The moveable rail 24 is supported and guided by the moving platform 23 such that it extends horizontally in a direction Y perpendicular to the direction X. An application nozzle 25 that can move up and down is mounted on an end of the moveable rail 24. In the application device 20, the movement of the moving platform 23 in the direction X, the movement of the moveable rail 24 in the direction Y, and the up-and-down movement of the application nozzle 25 are controlled by a control device (not shown in the drawings). A tip 25a of the application nozzle 25 is moved such that it follows the outer edge 31a of the joining end face 31 of the transmission housing 30 in close proximity to the joining end face 31. The paste-type liquid gasket 35 is discharged from the tip 25a of the application nozzle 25 and applied to the outer edge 31a of the joining end face 31.

As shown in FIGS. 1 and 2, the upper supporting portion of the support frame 27 extends over the liquid gasket application device 20, and the tilt device 29 is mounted on the underside of the upper supporting portion. The digital camera 28 is affixed to the tilt device 29 such that it faces downward and is positioned directly above the transmission housing 30 that is held in position in the application and detection station S. The tilt device 29 supports the digital camera 28 and can swivel around an X axis O1 parallel to the direction X and around a Y axis O2 parallel to the direction Y. The shape of the outer edge 31a of the joining end face 31 of the transmission housing 30 is stored in advance in the memory of a control device 40 by means of a teaching function. Based on the content that is stored in advance in its memory by the teaching function, the control device 40 controls the rotation of the tilt device 29 around the two axes O1 and O2 to swivel the digital camera 28 in such a way that the center of its field of view moves along the outer edge 31a of the joining end face 31 of the transmission housing 30 that is held in position in the application and detection station S. The control device 40 also has a program in its memory that controls the operation of the digital camera 28 in such a way that when the control device 40 controls the operation of the tilt device such that the digital camera 28 swivels, the focal distance matches the distance to the liquid gasket 28 that is applied to the joining end face 31 of the transmission housing 30.

In this embodiment, the digital camera 28 is a camera that is capable of color photography and that has an automatic exposure-adjustment function that automatically adjusts the exposure to match the brightness of the liquid gasket that is the subject, as well as an automatic focusing function that matches the focus of the lens to the subject and a lens focal distance change function (zoom function).

As shown in FIG. 1, a display device 41, such as a CRT, for example, is connected to the control device 40. The control device 40 has a program in its memory that processes a digital image taken by the digital camera 28 of the liquid gasket 35 that is applied to the joining end face 31 of the transmission housing 30, detects the state of adhesion of the liquid gasket 35, and when a defective location is found in the image, displays the defective location on the display device.

Next, a method of processing an image taken by the digital camera and a method of using the image to detect the state of adhesion of the liquid gasket that is the subject will be explained together with the operation of the application device 20. The transmission housing 30, which is mounted on the pallet 11 such that the joining end face 31 is positioned on the top side, is carried by the roller conveyor 10 to the application and detection station S, where it is held in position by the cylinder device 15. The liquid gasket 35 is applied by the liquid gasket application device 20 along the outer edge 31a of the joining end face 31. When the application device 20 no longer obstructs photography of the portion to which the liquid gasket 35 has been applied, the digital camera 28 starts to take images.

During the taking of images, the tilt device 29 and the digital camera 28 operate under the control of the control device 40 as described below. With the transmission housing 30 held in position by the cylinder device 15, the liquid gasket 35 is applied to the joining end face 31 by the application device 20. Next, the rotation of the tilt device 29 around the two axes O1 and O2 is controlled in such a way that the center of the field of view of the digital camera 28 moves along the outer edge 31a of the joining end face 31 of the transmission housing. During this operation, the operation of the tilt device 29 is controlled in such a way that the range photographed by the digital camera 28 moves intermittently, a little bit at a time, along the outer edge of the joining end face 31, so that the ranges of successive images overlap. The operation of the digital camera 28 is controlled such that the liquid gasket 35 that is applied to the joining end face 31 is photographed at a plurality of locations. To enable the execution of the image capture operation, the shape of the outer edge of the joining end face 31 and the distance to each photographed location on the liquid gasket 35 that is applied to the joining end face 31 are stored in the memory of the control device 40, and the control device 40 is programmed to adjust the focal distance of the digital camera 28 to match the object distance for each photographed location. The program causes the control device 40 to control the operation of the digital camera 28 such that the image resolution is constant in every photographed range of the liquid gasket 31. Note that the lens exposure adjustment and focusing at each photographed location is done by the digital camera 28 itself. The image data for the liquid gasket that is photographed in this manner is stored in the memory of the control device 40.

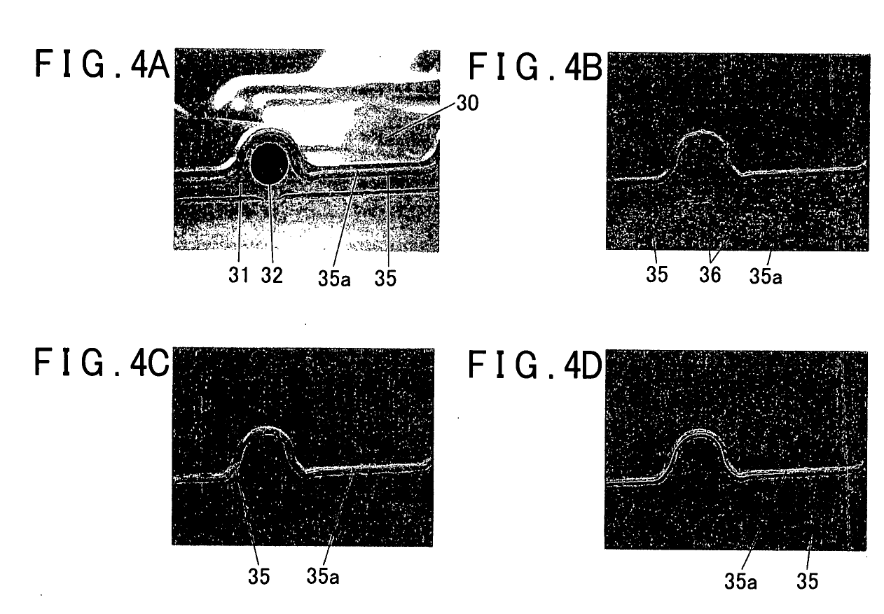

Next, a method of detecting and inspecting the state of adhesion of the liquid gasket 35 that is applied to the joining end face 31 and is photographed as described above will be explained with reference to FIGS. 4A to 4D. FIG. 4A shows an image of the liquid gasket 35 that was taken as described above and that contains a break 35a.

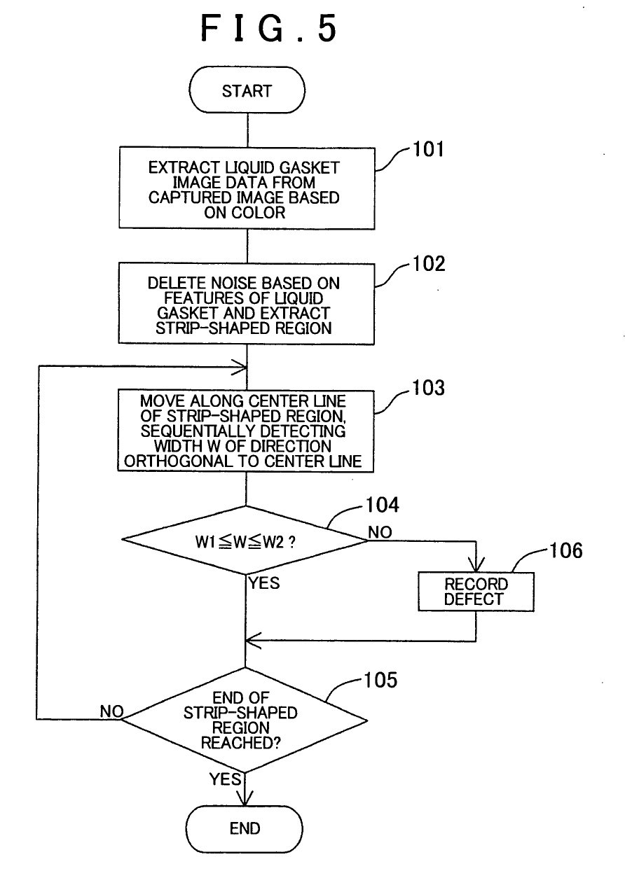

In this embodiment, the control device 40 executes the program shown in FIG. 5 to extract image data for the liquid gasket 35 from the image that was taken by the digital camera 28 and, based on the extracted image data, to judge the state of adhesion of the liquid gasket 35 that was applied to the joining end face 31 of the transmission housing. In step 101 in the flowchart shown in FIG. 5, the control device 40 extracts the image data for the liquid gasket 35 from the image shown in FIG. 4A, based on the color of the liquid gasket 35 (e.g., red). The extracted image data contains noise, indicated by the number 36 in FIG. 4B, from red areas that occur in the image shown in FIG. 4A. Accordingly, in step 102, the control device 40 deletes the noise that occurs in the image in FIG. 4B to extract a strip-shaped region containing only the liquid gasket 35, as shown in FIG. 4C. Next, in step 103, the control device 40 detects the center line of the extracted strip-shaped region, as shown in FIG. 4D, and then detects the width W of the strip-shaped region in the direction orthogonal to the center line, working its way along the center line sequentially.

Every time the control device 40 detects the width W of the strip-shaped region in step 103, it judges the width W in step 104 according to the equation below.

W1≦W≦W2

where W1 is a minimum width (e.g., 1.0 mm)
and W2 is a maximum width (e.g., 1.5 mm).
If W1≦W≦W2, the width is judged to be good. If not W1≦W≦W2, the width of the liquid gasket 35 at the detected position is judged to be defective, and the judgment result is recorded in memory in step 106. Next, in step 105, the program judges whether or not the detection position for the width W has reached the end of the strip-shaped region. If the end has not been reached, the processing in steps 103 to 106 is repeated. When the end is reached, the execution of the program shown in FIG. 5 ends. In this manner, the control device 40 detects the state of adhesion of the liquid gasket 35 by continuously executing the program in FIG. 5 for the next set of image data.

In the judgment result that the control device 40 recorded in memory in step 106 of the detection process described above, if W=0, a break is judged to exist in the liquid gasket 35. If 0<W<W1, the width of the liquid gasket 35 is judged to be too small, and if W>W2, the width of the liquid gasket is judged to be too large. If a break exists in the liquid gasket 35 or if its width is too small, when a mating member is joined to the joining end face 31 of the transmission housing 30, there is a risk that oil will leak from the joint. If the width of the liquid gasket 35 is too large, when a mating member is joined to the joining end face 31 of the transmission housing 30, the liquid gasket will bulge out from the joint, intruding as foreign matter into the interior of the transmission and hindering the operation of the transmission.

To eliminate the flaw that caused the adhesion defect in the liquid gasket 35 described above, the control device 40 displays the judgment result recorded in its memory on the CRT display device 41, along with the serial number of the transmission housing in question. In the display, the location of the adhesion defect in the liquid gasket is displayed with a red circle around it. When the transmission housing comes off the conveyor line 11, the operator inspects the location on the joining end face that is marked by the red circle. If the defect can be corrected, the operator corrects it, and if the flaw cannot be corrected, the transmission housing is stored in an appropriate storage site.

In this embodiment, in order to photograph the liquid gasket 35 that is applied to the joining end face 31 of the transmission housing 30, the digital camera 28, which is capable of color photography, has an automatic exposure function and an automatic focal distance change function and is mounted on the tilt device 29 described above. In the liquid gasket image data captured by the digital camera 28, this reduces variations in brightness caused by ambient light and allows image data suitable for image processing to be obtained in which the images of the liquid gasket are not blurry, even if the object distance varies in relation to the transmission housing joining end face that is the subject. The digital camera 28, driven by the tilt device, swivels in such a way that the center of its field of view moves along the transmission housing joining end face that is the subject. This makes it possible for a single camera to photograph all of the inspected portions of the subject, regardless of the size of the subject or the resolution of the range photographed.

In the practice of the present invention, in order for a break in the liquid gasket 35 of around 0.2 mm to be detected, the image resolution of the subject must be around 0.2 mm per pixel. Therefore, if a CCD camera is used in which the effective number of pixels is 640 in the width direction and 480 in the height direction, the range of the joining end face 31 that is photographed by the digital camera 28 must be narrowed down to around 64 mm wide by 48 mm high, if noise is taken into account. This is a small value in comparison to the overall width and height (e.g., 360 mm×300 mm) of the joining end face 31 of the transmission housing 30. However, because the digital camera 28 photographs only the outer edge of the joining end face 31, the image capture time does not increase in proportion to the narrowing down of the photographed range in each image.

In the practice of the present invention, the digital camera 20 is swiveled by the operation of the tilt device 29 in order to photograph the joining end face 31 that is the subject. For that reason, the object distance varies in relation to the subject such that the resolution of the photographed range of the subject is different in each image. However, the digital camera 28 has a focal distance change function such that every time the field of view reaches an inspected portion of the liquid gasket that is applied to the joining end face 31, the resolution of the photographed region is substantially constant. This makes the captured images uniform and suitable for digital processing.

In the embodiment described above, overlapping images of the liquid gasket that is applied to the joining end face 31 of the transmission housing are taken sequentially. However, the present invention is not limited to a joining end face of a transmission housing, but is clearly suitable for inspecting joining end faces of parts having various shapes and for inspecting the condition of members adhering to joining end faces. Also in the embodiment described above, in step 101 of the program shown in FIG. 5, image data is extracted based on the (red) color of the liquid gasket 35 in such a way that the liquid gasket image data is extracted without being affected by pins, etc., located in the vicinity of the gasket. This makes it possible to accurately inspect the state of adhesion of the liquid gasket. This advantage can clearly be attained even if image data is extracted based on a different color of a sealing member such as a liquid gasket, etc.

1. A method of photographing an inspected portion of a subject, comprising the steps of:
arranging a camera that has an automatic focusing function in such a way that it can swivel to a prescribed position facing the subject to be inspected;
swiveling the camera in such a way that its field of view moves sequentially along an inspected portion of the subject;
capturing an image, by means of the camera, every time the camera's field of view reaches an inspected portion of the subject; and
inspecting the condition of the subject by processing the image data of the inspected portion that was photographed.

2. The method of photographing according to claim 1, wherein
the camera has an automatic exposure adjustment function that automatically adjusts the exposure when an inspected portion of the subject is photographed in color.

3. The method of photographing according to claim 1, wherein
the camera has a focal distance change function that adjusts the focal distance of the camera in such a way that every time the camera's field of view reaches an inspected portion of the subject, the resolution of the photographed range is substantially constant.

4. A method of inspecting the state of adhesion of a paste-type member, comprising the steps of:
arranging a camera that has an automatic focusing function in such a way that it can swivel to a prescribed position facing the subject, to the upper surface of an outer edge of which a paste-type member adheres in the form of a continuous strip;
swiveling the camera in such a way that its field of view moves sequentially along an outer edge of the subject;
capturing an image, by means of the camera, every time the camera's field of view reaches an inspected portion of the paste-type member that adheres in the form of a strip to the upper surface of an outer edge of the subject;
extracting color or shading from the captured image and deleting noise from the image data of the captured image;
sequentially detecting the width of the extracted strip-shaped region of the paste-type member;
judging whether or not the strip-shaped region is of a prescribed width; and
determining if the state of adhesion of the paste-type member is defective by judging whether the width of the detected strip-shaped region is too much wider or too much narrower than the prescribed width.

5. The method of inspecting the state of adhesion of a paste-type member according to claim 4, further comprising the step of:
displaying on a display device the judgment result of whether the width of the detected strip-shaped region is too much wider or too much narrower than the prescribed width.

6. The method of inspecting the state of application of a paste-type member according to claim 4, wherein
the paste-type member that adheres to the upper surface of an outer edge of the subject in the form of a continuous strip is a liquid gasket.

7. A photographic device for inspecting the condition of a member that adheres to an inspected portion of a subject, comprising:
a camera that has an automatic focusing function and is arranged in such a way that it can swivel to a prescribed position facing the subject to be inspected;
driving means for driving the camera in such a way that the camera's field of view moves sequentially along an inspected portion of the subject;
means for operating the camera in such a way that every time its field of view reaches an inspected portion of the subject, the camera photographs the inspected portion; and
image processing means for processing the image data of an inspected portion that was photographed by the camera.

8. The photographic device according to claim 7, wherein
the camera has a focal distance change function that adjusts the focal distance of the camera in such a way that every time the camera's field of view reaches an inspected portion of the subject, the resolution of the photographed range is substantially constant.

9. A device for inspecting the state of adhesion of a paste, comprising:
a camera that has an automatic focusing function and is arranged in such a way that it can swivel to a prescribed position facing a subject, to the upper surface of an outer edge of which a paste is applied in the form of a continuous strip;
driving means for driving the camera in such a way that the camera's field of view moves sequentially along an outer edge of the subject;
means for operating the camera in such a way that every time its field of view reaches an inspected portion of the paste that adheres in a strip shape to the upper surface of an outer edge of the subject, the camera photographs the paste that is located at the inspected portion;
processing means for extracting color or shading from the image captured by the camera and delete noise from the image data of the image; and
judgment means for sequentially detecting the width of the extracted strip-shaped region of the paste, judging whether or not the strip-shaped region is of a prescribed width, and determining if the state of adhesion of the paste is defective by judging whether the width of the detected strip-shaped region is too much wider or too much narrower than the prescribed width.

10. The device for inspecting the state of adhesion of a paste according to claim 9, characterized by further comprising:
a display device that displays the judgment result in a visually recognizable way when the state of adhesion of the paste is judged to be defective by the judgment means.
